(19) United States
(12) Patent Application Publication
(10) Pub. No.: US 2026/0093975 A1
(43) Pub. Date: Apr. 2, 2026

(54) PERSONALIZED INTENT AUTOMATION USING DYNAMIC PROMPT GENERATION FOR A MACHINE LEARNING MODEL

(71) Applicant: INTUIT INC., Mountain View, CA (US)

(72) Inventors: Rachita RAMESH, San Francisco, CA (US); Gaurav BUDJADE, Santa Clara, CA (US); Neha JAYAPRAKASH, Mountain View, CA (US); Nava Teja TUMMALAPALLI, Newark, CA (US); Sujay SUNDARAM, San Jose, CA (US)

(21) Appl. No.: 18/900,355

(22) Filed: Sep. 27, 2024

(51) Int. Cl. G06N 3/08; G06N 3/0475

(52) U.S. Cl. CPC G06N 3/08; G06N 3/0475

(57) ABSTRACT

Aspects of the present disclosure provide techniques for automated software application guidance. Embodiments include detecting that a trigger event associated with a user has occurred within a software application. Embodiments include aggregating data related to the user from one or more data sources based on recommendable actions associated with the trigger event. Embodiments include generating a prompt for a machine learning model based on the aggregated data, the recommendable actions, and scores associated with the recommendable actions. Embodiments include providing the prompt to the machine learning model. Embodiments include receiving, from the machine learning model in response to the prompt, a recommended action of the recommendable actions. Embodiments include displaying an indication of the recommended action via the software application. Embodiments include receiving feedback from the user with respect to the recommended action and updating one or more of the scores associated with the recommendable actions based on the feedback.

### INTRODUCTION

Aspects of the present disclosure relate to techniques for automatically guiding a user of a software application using intent predictions based on dynamically generated prompts for a machine learning model.

### BACKGROUND

Every year millions of people, businesses, and organizations around the world utilize software applications to assist with countless aspects of life. Many software applications utilize machine learning models to make predictions related to application functionality. For example, a language processing machine learning model may be used to generate recommendations for a user of a software application based on data related to the user.

Existing software applications generally provide all data that is known to be potentially relevant as inputs to a machine learning model in connection with making a prediction. For example, all available data of a user may be provided as context to a language processing machine learning model when prompting such a model to make a prediction related to the user. However, in many cases providing a model with too much information and/or with irrelevant information can produce incorrect results, utilize unnecessarily large amounts of computing resources, and/or otherwise negatively impact performance. In many cases, it may be challenging to automatically determine which information is relevant to a particular prediction, and existing techniques often result in providing too much information and/or irrelevant information to the model.

As such, there is a need in the art for improved techniques of automatically determining relevant information to provide to a machine learning model.

### BRIEF SUMMARY

Certain embodiments provide a method for automated software application guidance. The method generally includes: detecting that a trigger event associated with a user has occurred within a software application; aggregating data related to the user from one or more data sources based on recommendable actions associated with the trigger event; generating a prompt for a machine learning model based on the aggregated data, the recommendable actions, and scores associated with the recommendable actions; providing the prompt to the machine learning model; receiving, from the machine learning model in response to the prompt, a recommended action of the recommendable actions; displaying an indication of the recommended action via the software application; receiving feedback from the user with respect to the recommended action; and updating one or more of the scores associated with the recommendable actions based on the feedback.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example user interface screen related to automated software application guidance through intent-based machine learning, according to certain embodiments.

FIG. 2 is a diagram illustrating example computing components related to automated software application guidance through intent-based machine learning, according to certain embodiments.

FIG. 3 is a diagram illustrating an example hierarchy of actions and intents related to automated software application guidance through intent-based machine learning, according to certain embodiments.

FIG. 4 is a diagram illustrating example relationships between events, intents, and data sources related to automated software application guidance through intent-based machine learning, according to certain embodiments.

FIG. 5 depicts example operations related to automated software application guidance, according to certain embodiments.

FIG. 6 depicts an example processing system for automated software application guidance through intent-based machine learning, according to certain embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automated software application guidance through intent-based machine learning.

Software applications may include large amounts of functionality that can be invoked by users. Furthermore, large amounts of data related to use of software applications by users may be collected and available for analysis. In some software applications, data related to users may be used to predict future activity by such users and/or to otherwise determine recommendations to provide to the users. For example, machine learning techniques may be used to predict which application functionality is likely to be most useful to a particular user based on data related to the user. However, due to the large amounts of available data, it can be challenging to automatically determine which data is relevant or most useful to such a prediction. As a result, without techniques described herein, a machine learning model may be provided with an excessively large amount of data and/or with data that is irrelevant to a particular prediction task, resulting in unnecessarily large amounts of computing resource utilization, incorrect results, and/or otherwise poor performance.

Embodiments of the present disclosure overcome these challenges through a dynamic, feedback-based automated scoring system by which relevant and useful information is automatically retrieved and used to provide targeted context to a machine learning model. For example, such targeted context information may be provided in connection with prompting the model to generate action recommendations based on events occurring within a software application.

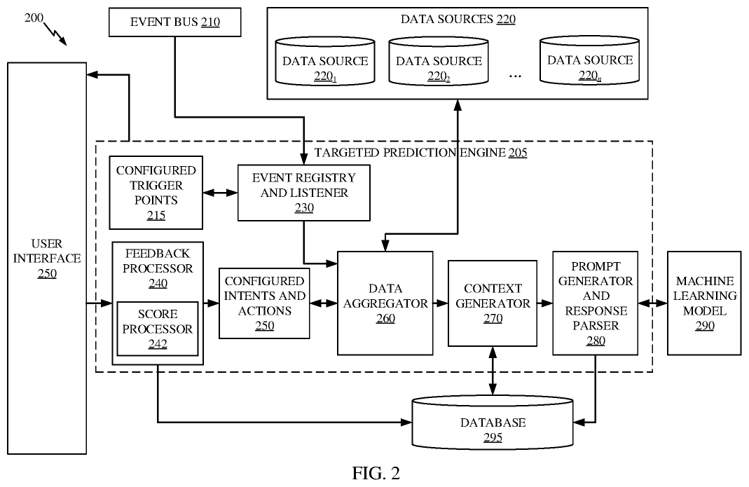

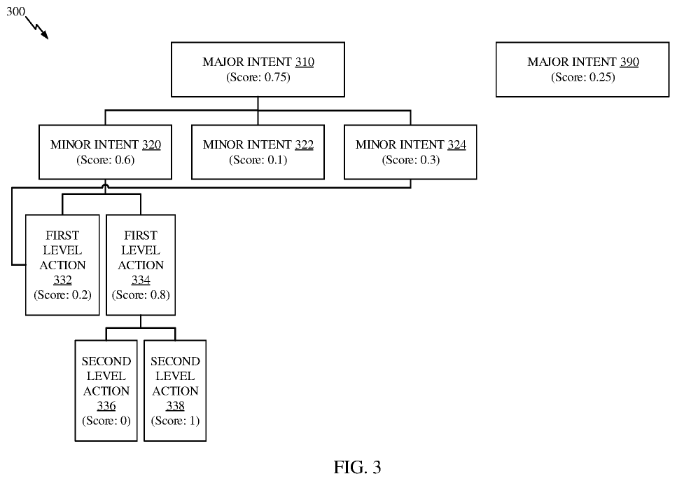

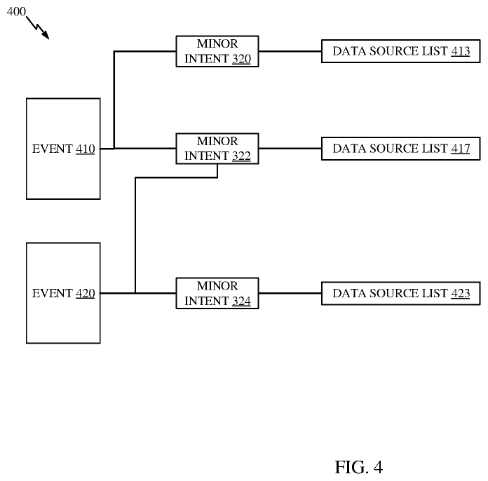

While some existing machine learning based techniques may involve providing all potentially relevant information about a user to a machine learning model, techniques described herein use configured associations and dynamically computed scores to automatically identify specific information from particular data sources that is most likely to be relevant and useful to a given prediction task. As described in more detail below with respect to FIG. 2, a targeted prediction engine may listen for events occurring within a software application, and may initiate an automated action recommendation process upon detecting certain trigger events performed by a user. As described in more detail below with respect to FIGS. 3 and 4, a hierarchy of recommendable actions associated with different intents may be linked to particular trigger events, and data sources associated with applicable recommendable actions may be queried for relevant data to be provided as context to a machine learning model. Scores associated with recommendable actions and/or intents may be used to select which data sources to query and/or to provide the machine learning model with relevant context data. For example, the scores may be determined based on user feedback with respect to prior action recommendations.

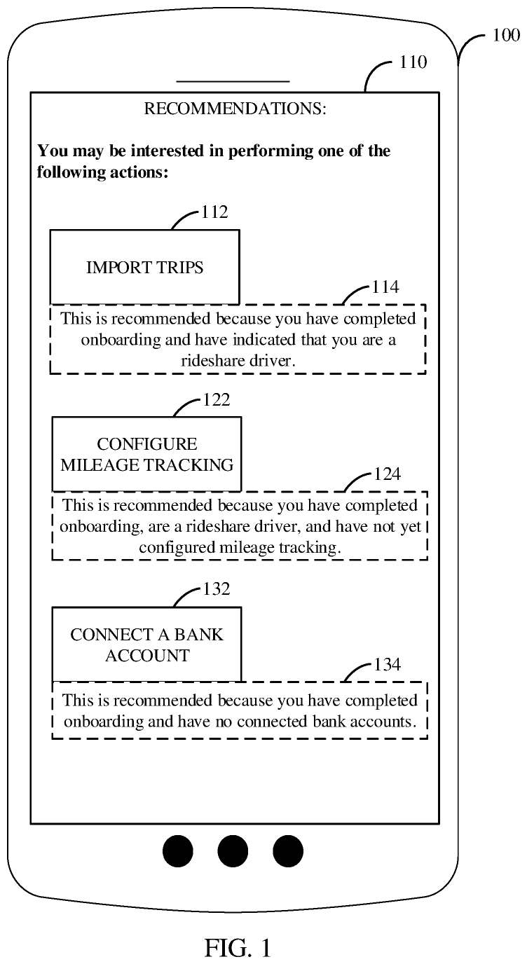

The machine learning model, which may be a language processing machine learning model such as a large language model (LLM), may output one or more recommended actions in response to a prompt that includes the selected context data. As described in more detail below with respect to FIG. 1, such recommended actions may be displayed via a user interface associated with the application, such as in connection with user interface controls that allow a user to initiate performance of the recommended actions within the application. The user may provide feedback with respect to the recommended actions, such as by selecting or not selecting a recommended action, and the user feedback may be used to dynamically update scores associated with the recommended actions. These updated scores may be used in subsequent action recommendation processes, such as to determine which data sources to use for context data and/or to provide the machine learning model with the updated scores for use in recommending actions.

Techniques described herein improve the technical field of automated software application guidance in a number of ways. For instance, by using a dynamic feedback-based scoring mechanism to selectively obtain targeted context information to provide to a machine learning model in connection with generating action recommendations, embodiments of the present disclosure enable focused and resource-efficient generation of action recommendations in an accurate manner. The use of configured associations between events and actions and between actions and data sources enables dynamic data source selection based on scores associated with actions when a particular event occurs, thereby producing a more focused and relevant set of context data. Furthermore, configured hierarchical relationships among actions and intents allows machine learning models to be provided with information that is more informative and contextualizing in connection with generating action recommendations as opposed to providing a machine learning model with information about individual actions without reference to one another or to higher-level intents. Thus, techniques described herein produce action recommendations that can be used to automatically guide a user of an application in a manner that is more accurate, focused, and resource-efficient than other techniques for automated action recommendations (e.g., techniques that provide a machine learning model with all available potentially relevant data and/or isolated actions without relational information).

Additionally, by utilizing feedback from users on an ongoing manner to dynamically update scores associated with actions, and by using such dynamically updated scores to determine which data sources to select and/or to provide more informative context information to the machine learning model, techniques described herein involve an interactive feedback loop by which the automated action recommendation process is continuously improved, false positives are reduced, and resource utilization is continually optimized (e.g., by using a more limited and focused data set as context and by avoiding generation of inaccurate action recommendations). Thus, embodiments of the present disclosure improve the accuracy of a machine learning model that generates automated action recommendations, improves resource utilization with respect to computing devices involved, and improves functionality of a computing application by automatically recommending optimal actions to perform within the computing application and avoiding inefficient and/or ineffective use of the application. Additionally, by displaying targeted and accurate action recommendations that are dynamically generated using techniques described herein via a user interface, such as in association with explanations of the action recommendations, techniques described herein improve the usability of such a user interface.

### Example User Interface Screen Related to Automated Software Application Guidance

FIG. 1 depicts an example user interface screen 110 on a computing device 100 related to automated software application guidance through intent-based machine learning, according to certain embodiments. For example, user interface screen 110 may be an example screen of user interface 250 of FIG. 2, described below.

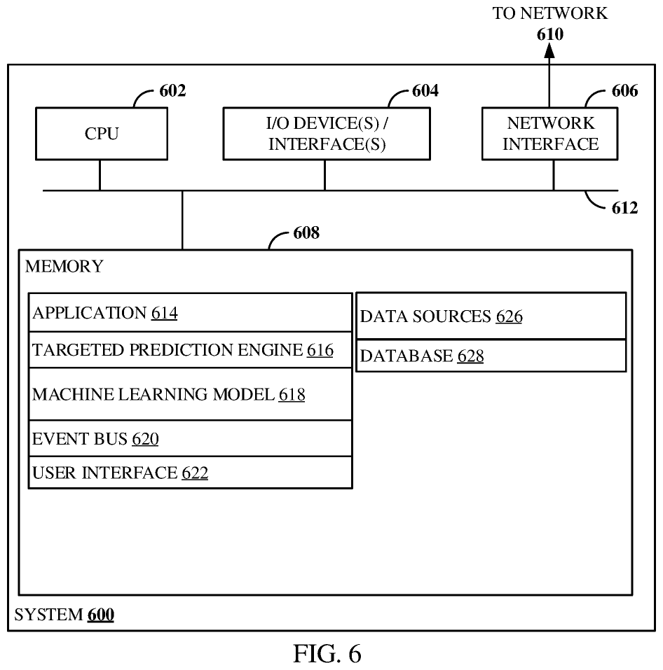

Device 100 may be representative of a computing device such as system 600 of FIG. 6 (described below) on which one or more software applications may be executed. In some embodiments, aspects of functionality described herein may be performed on device 100, while other aspects of functionality described herein may be performed on one or more separate computing devices, such as one or more servers, connected to system 100 via a network (e.g., the Internet or another connection over which data may be transmitted). In one example, device 100 is a mobile device such as a smartphone.

User interface screen 110 displays recommended actions that can be performed by a user within a software application. For example, user interface screen 110 may be displayed after an event occurred (e.g., after the user completed some action or workflow or some other event occurred) and prompted an automated action recommendation process such as that described in more detail below with respect to FIG. 2. In the depicted, example, user interface screen 110 indicates that the user may be interested in performing one of a list of recommended actions, and includes user interface elements 112, 122, and 132 that initiate performance of the recommended actions when selected. User interface elements 112 122 and 132 may also be displayed in connection with natural language explanations of the action recommendations, such as in user interface panels 114, 124, and 134. For example, user interface panel 114 may include a natural language explanation of the action recommendation corresponding to user interface element 112, and may be displayed proximate to user interface element 112. User interface panel 124 may include a natural language explanation of the action recommendation corresponding to user interface element 122, and may be displayed proximate to user interface element 122. User interface panel 134 may include a natural language explanation of the action recommendation corresponding to user interface element 132, and may be displayed proximate to user interface element 132.

In the depicted example, the first recommended action (indicated in user interface element 112) is importing trips (e.g., for tax preparation purposes). For example, the action of importing trips may be associated with the minor intent of allowing location services tracking and the major intent of getting ready for taxes. Selecting user interface element 112 may cause the application to navigate to a user interface screen for importing trips, such as providing additional user interface elements that allow the user to provide information to enable such an import. User interface panel 114 includes a natural language explanation of the recommendation indicated in user interface element 112, such as “this is recommended because you have completed onboarding and have indicated that you are a rideshare driver.” In other embodiments (not shown), a confidence score and/or one or more intents (e.g., a minor intent and/or a major intent) associated with the action recommendation may be displayed proximate to user interface element 112.

The second recommended action (indicated in user interface element 122) is configuring mileage tracking (e.g., for tax preparation purposes). For example, the action of configuring mileage tracking may be associated with the minor intent of allowing location services tracking and the major intent of getting ready for taxes. Selecting user interface element 122 may cause the application to navigate to a user interface screen for configuring mileage tracking, such as providing additional user interface elements that allow the user to provide configuration information for mileage tracking. User interface panel 124 includes a natural language explanation of the recommendation indicated in user interface element 122, such as “this is recommended because you have completed onboarding, are a rideshare driver, and have not yet configured mileage tracking.” In other embodiments (not shown), a confidence score and/or one or more intents (e.g., a minor intent and/or a major intent) associated with the action recommendation may be displayed proximate to user interface element 122.

The third recommended action (indicated in user interface element 132) is connecting a bank account (e.g., for importing financial data such as transactions). For example, the action of connecting a bank account may be associated with the minor intent of cash flow and the major intent of providing a holistic view of finances. Selecting user interface element 132 may cause the application to navigate to a user interface screen for connecting a bank account, such as providing additional user interface elements that allow the user to provide account information for connecting a separate bank account to the user's account with the software application. User interface panel 134 includes a natural language explanation of the recommendation indicated in user interface element 132, such as “this is recommended because you have completed onboarding and have no connected bank accounts.” In other embodiments (not shown), a confidence score and/or one or more intents (e.g., a minor intent and/or a major intent) associated with the action recommendation may be displayed proximate to user interface element 132.

Displaying three recommended actions in the particular format depicted in FIG. 1 is an example, and other numbers of recommended actions and other display formats may be used with techniques described herein.

### Example Computing Components Related to Automated Software Application Guidance

FIG. 2 is a diagram 200 illustrating example computing components related to automated software application guidance, according to certain embodiments.

In diagram 200, a targeted prediction engine 205 comprises an event registry and listener 230, which listens for events occurring within a software application, such as events that are published to an event bus 210. Targeted prediction engine 205 generally represents a software component that executes on one or more physical computing devices and that performs functionality related to automatically generating action recommendations.

Event bus 210 generally receives indications of events that occur in connection with use of a software application by a user. For example, such events may include completion of a workflow (e.g., an onboarding workflow) or action (e.g., navigating to a certain page or location within the application), configuration events (e.g., updating a user preference, connecting a separate user account such as a bank account to the application, and/or the like), security events, communication events, automated or assisted support events, combination of events (e.g., performing a particular action a particular number of times), and/or the like.

Event registry and listener 230 generally monitors event bus 210 for the occurrence of certain events that are indicated as triggers in configured trigger points 215. For example, configured trigger points 215 may comprise events that are configured as trigger points for initiated an automated action recommendation process. If event registry and listener 230 detects an event on event bus 210 that is listed as a trigger in configured trigger points 215, then the automated action recommendation process may be initiated, such as beginning with data aggregator 260 retrieving and aggregating data related to the event and/or user from one or more data sources 220 according to configured intents and tasks 250 associated with the event.

Configured intents and actions 250 may include associations between various actions that can be performed within the software application and intents and, in some embodiments, between certain events in configured trigger points 215 and particular actions. As described in more detail below with respect to FIG. 3, configured intents and actions 250 may be arranged hierarchically, such as with major intents (e.g., at a top hierarchical level), minor intents (e.g., at a level below the top hierarchical level), and actions (e.g., at one or more hierarchical levels below minor intents). For instance, each action may be part of one or more minor intents and each minor intent may be part of one or more major intents. Furthermore, some actions may be sub-actions of other actions. Such a hierarchical framework may enable better contextualization of each action within broader operational sequences represented by different intents. Each action may be referred to as a recommendable action because it can be recommended to a user of the software application. As described in more detail below with respect to FIG. 4, events may be associated with particular actions (e.g., actions that may be relevant when a given event occurs) and/or intents (e.g., that have actions associated with them), and each action (and/or intent) may be associated with a list of data sources (e.g., including one or more of data sources 220) including data that may be relevant to the action or intent.

Data aggregator 260 may determine which actions and/or intents are associated with the event that has occurred, and may determine which of data sources 220 are associated with those actions and/or intents. Data aggregator 260 may then retrieve data from one or more of those determined data sources 220. As described in more detail below with respect to feedback processor 240, data aggregator 260 may use scores associated with corresponding actions and/or intents to determine which of the determined data sources to use. For example, data aggregator 260 may retrieve data only from data sources that are associated with actions and/or intents (e.g., associated with the event) having a score greater than 0 (or above some other threshold). In some embodiments, if any actions or intents associated with the event have a score of 0 (or below some other threshold), then data aggregator 260 may determine not to retrieve data from any data sources associated with such actions or intents. Other implementations are possible and, more generally, some embodiments may involve using scores associated with actions and/or intents to dynamically determine which data sources to use (e.g., for retrieving data to use as a context data).

Data sources 220 (e.g., data sources 2201-») generally represent sources of data related to one or more users of an application. For example, data source 2201 may be a data store that includes user banking data (e.g., transactions, account details, and/or the like), data source 2202 may be a data store that includes user action data and/or other product data (e.g., clickstream data and/or records of actions performed within the software application), data source 2203 may be a data store that includes user profile data (e.g., including user attributes such as occupation, length of use of the application, expertise, preferences, geographic location, and/or the like) from one or more profiles (e.g., user profile, tax profile, and/or the like), data source 2204 may be a data store that includes audit logs, data source 2205 may include one or more spreadsheets and/or other documents, data source 2206 may include website data, and/or the like. These types of data sources are included as examples, and other types of data sources may be used with techniques described herein.

Data aggregator 260 may perform certain cleaning, filtering, and/or refactoring on the data that it receives from one or more data sources 220, such as according to rules that are particular to each data source. For instance, data from a banking data source may be translated into a standardized format that is common to multiple banking data sources or all banking data sources, such as using standardized terminology (e.g., converting terms like “charge” or “payment” into a standardized term such as “debit” and/or the like) and/or representation styles (e.g., whether debits or credits are represented as negative or positive numerical values). Data may also be anonymized and/or otherwise stripped of sensitive information. In some cases, only certain types of data from a particular data source are included in the context while other types of data are excluded. For example, for transactions stored in a banking data source, information such as date, description of transaction, amount, and type of transaction may be extracted for each transaction and included in the context while other types of information may be excluded. The data from each applicable data source may be processed in its own unique pipeline, such as according to logic and/or rules specific that applicable data source, to produce aggregated (e.g., combined, cleaned, filtered, refactored, and/or the like) data. For example, such unique pipelines may enable data from different data sources to be processed in parallel to produce aggregated data in a resource-efficient manner.

Data aggregator 260 may provide the data aggregated from one or more data sources 220 (e.g., after performing cleaning, filtering, and/or refactoring on such data) to context generator 270. Context generator 270 used the data from data aggregator 260 to generate context data for providing to a machine learning model 290 along with a prompt. For example, context generator 270 may include, in the context data, the data from data aggregator 260, a list of recommendable actions (e.g., which context generator 270 may retrieve from a database 295), scores associated with the data and/or the recommendable actions (e.g., the scores may be retrieved from database 295), and/or the like. In some embodiments, context generator 270 includes scores associated with given actions (e.g., scores directly associated with the action and/or indirectly associated with the actions, such as scores associated with intents that are associated with the actions) as scores (e.g., weights) for the actions and as scores (e.g., weights) for data from data sources associated with those given actions when creating context data. Context generator 270 may also include information about previously recommended actions, such as whether such actions were performed and/or intents associated with such actions (e.g., to contextualize the user's current position in one or more workflows). Generally, the context may include information about actions previously performed by the user and, in some embodiments, intents associated with those actions.

In some embodiments, context generator 270 vectorizes some or all of the information that it includes in the context, such as the list of recommendable actions. For example, context generator 270 may generate an embedding of each recommendable action and include the embeddings of the recommendable actions in the context. Context generator 270 may generate embeddings of the aggregated data from data aggregator 260 and include the embeddings of the aggregated data in the context. An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities. In certain embodiments, information included in the context is provided to machine learning model 290 in text form, and is vectorized within machine learning model 290 rather than being vectorized prior to being provided to machine learning model 290. Utilizing vector representations of items such as recommendable actions may allow latent similarities between such items and/or semantic meanings of such items to be used to inform determinations made by machine learning model 290 in a way that would not be possible based only on the text itself in its native form.

The context data generated by context generator 270 may be provided to prompt generator and response parser 280, which may generate a prompt based on the context data. For example, prompt generator and response parser 280 may generate a natural language prompt (e.g., based on a prompt template, stored prompts, and/or prompt generation rules) that instructs machine learning model 290 to generate one or more action recommendations based on associated context, such as including the context data from context generator 270 as context with the prompt. For example, the prompt may instruct machine learning model 290 to select a given number of actions from a list of recommendable actions in the context based on other data in the context and/or based on the event that occurred (e.g., information about the event that was detected by event registry and listener 230 may also be included in the context data). The scores/weights included in the context may be used by machine learning model 290 to weight data from particular data sources differently and/or to weight particular recommendable actions differently. In some embodiments, the prompt also instructs machine learning model 290 to generate a natural language explanation of the one or more action recommendations (e.g., explaining which factors in the context contributed most to each of the one or more action recommendations).

In some embodiments, the weight for each action indicated in the prompt (and, in some cases, for each data source associated with the action) is based on the minor intent for that action (e.g., based on the score for the minor intent and/or other factors related to the minor intent such as its impact on user engagement, retention, revenue, and/or the like). Weights generally emphasize to machine learning model 290 which data source(s) should be relied on most significantly as source(s) of truth.

In one example, a calculation of a weight Wi for an action (i) may defined as

Wi=(Importance Factor/Total Importance Factors)×Maximum Weight,

where Wi=the weight of action (i), Important Factor is a measure of importance of the action, determined based on factors like its score, its impact on user engagement, retention, revenue, and/or the like, Total Importance Factors is the sum of Importance Factors for all actions, and Maximum Weight is the highest weight that can assigned to any task (e.g., 1, 10, or the like).

The prompt generated by prompt generator and response parser 280 may be provided to machine learning model 290, and machine learning model 290 may generate an output based on the prompt. For example, machine learning model 290 may output one or more action recommendations (e.g., selected from the recommendable actions included with the prompt) and, in some embodiments, natural language explanations of each of the one or more action recommendations. In some cases, machine learning model 290 also outputs confidence scores for each of the one or more action recommendations. An action recommendation generally refers to an indication that a particular action is recommended to be performed within the software application. In one embodiment, such as when instructed by the prompt to do so, machine learning model 290 outputs a structured object such as a Javascript object notation (JSON) object that includes identifiers of one or more recommended actions and, in some embodiments, associated intents, confidence scores and/or natural language explanations of those one or more recommended actions.

Machine learning model 290 may, for example, be a language processing machine learning model such as a large language model (LLM). Language processing machine learning models are generally neural networks, such as deep neural networks, that are trained using large amounts of natural language training data to generate natural language responses when provided with natural language queries (e.g., prompts). For example, machine learning model 290 may be a generative pre-trained (GPT) model or other type of language processing machine learning model that has been trained on a large set of training data (e.g., natural language text data), and is capable as a result of such training to perform a wide variety of language-related tasks in response to natural language prompts. In some embodiments, machine learning model 290 has been fine tuned (e.g., after machine learning model 290 has been trained more generally) for one or more particular tasks or domains, such as for use with a particular software application or for a specific purpose (e.g., action recommendations for a particular software application), while in other embodiments machine learning model 290 has been trained more generally without having been fine tuned. Machine learning model 290 may have a number of tunable parameters, which may have been iteratively adjusted during a supervised learning process based on training data.

Neural networks, for example, generally include a collection of connected units or nodes called artificial neurons. The operation of neural networks can be modeled as an iterative process. Each node has a particular value associated with it. In each iteration, each node updates its value based upon the values of the other nodes, the update operation typically consisting of a matrix-vector multiplication. The update algorithm reflects the influences on each node of the other nodes in the network. In some cases, a neural network comprises one or more aggregation layers, such as a softmax layer.

In certain embodiments, one or more action recommendations output by machine learning model 290 (e.g., in response to a prompt associated context) are provided as a response to prompt generator and response parser 280. Prompt generator and response parser 280 may parse the response (e.g., by parsing a structured object and/or otherwise extracting relevant data from the response) in order to determine which one or more actions are recommended. In some embodiments, prompt generator and response parser 280 stores the one or more action recommendations (e.g., with associated data such as scores and/or natural language explanations) in database 295.

Targeted prediction engine 205 may provide the one or more action recommendations to user interface 250 (e.g., after retrieving such recommendations from database 295) for display to a user of the software application, as described above with respect to FIG. 1. In some embodiments, the one or more action recommendations are displayed in connection with user interface elements that, when selected, initiate performance of the recommended actions (e.g., by navigating to a page of the application for performing a given action and/or otherwise causing an action to be initiated). The one or more action recommendations may also be displayed in association with the natural language explanation(s) output by machine learning model 290. Furthermore, in some embodiments, the one or more action recommendations are displayed in an order that it is determined based on confidence scores output by machine learning model 290 in association with the one or more action recommendations, such as displaying the action recommendation with a highest confidence score first, the action with a second highest confidence score second, and so on (e.g., as appropriate, such as when there are multiple action recommendations).

A user may view the one or more action recommendations via user interface 250, and may provide feedback by interacting with one or more user interface elements. For example, a user may select a recommended action or may choose not to select any recommended action. Such user feedback may be received by feedback processor 240, which may use the feedback to update aspects of the logic described herein. For example, a score processor 242 of feedback processor 240 may update scores associated with one or more actions or associated intents based on the feedback.

For instance, if feedback indicates that the user selected a particular recommended action, then a score update process may be performed. Each action may be associated with one or more intents, such as minor and major intents. A hierarchical arrangement of actions and intents along with associated scores determined based on feedback (e.g., determined by score processor 242) is described in more detail below with respect to FIG. 3. For example, if a user interacts with a particular action, then the score for that action may be increased (e.g., relative to other actions at the same hierarchical level) and/or a score for each of one or more intents associated with that action may be increased (e.g., relative to other intents at the same hierarchical level). Scores may be normalized at each hierarchical level such that scores of all actions at a particular level add up to one and scores of all intents at a particular hierarchical level add up to one. Generally, the score of an action or intent may indicate a likelihood of the user being interested in that action or intent relative to other actions or intents at the same hierarchical level.

An example of calculating scores based on feedback is described below with respect to FIG. 3. Scores determine by score processor 242 may be stored in database 295 and/or stored in connection with configured intents and actions 250 for use in dynamically selecting data sources for use in generating context information for particular events and for inclusion of the scores in context information, such that the scores allow machine learning model 290 to be provided with focused and relevant context information in connection with being prompted to generate action recommendations. In some embodiments, scores are user-specific, such that the scores for actions and intents for one user may be different than the scores for actions and intents of other users. In certain cases, scores determined for a first user based on feedback from the first user may be used for a second user based on determining that the second user is similar to the first user (e.g., if the first user and the second user share certain attributes, such as having a threshold number of shared attributes). This may be useful in a “cold start” situation in which little or no feedback has been received from the second user.

### Example Hierarchy of Actions and Intents Associated with Feedback-Based Scores

FIG. 3 is a diagram 300 illustrating an example hierarchy of actions and intents related to automated software application guidance through intent-based machine learning, according to certain embodiments.

In diagram 300, a first hierarchical level includes two major intents 310 and 390. Major intents may refer to high-level workflows or concepts in which other lower-level workflows, concepts, and/or actions are performed. Examples of major intents may include getting ready for taxes, providing a holistic view of finances, growing a business, and/or the like.

Beneath major intent 310 in the hierarchy are three minor intents 320, 322, and 324 at a second hierarchical level. While not show, major intent 390 may also have one or more minor intents beneath it. Minor intents may refer to lower-level workflows or concepts (e.g., lower than major intents) in which other lower-level actions are performed. Examples of minor intents include cash flow, profitability, allowing location services tracking, managing business goals, and/or the like.

Beneath minor intent 320 in the hierarchy are two “first level” actions 332 and 334 at a third hierarchical level (e.g., which is the first level for actions but third level overall). Actions generally refer to workflows or more granular tasks that can be performed in the software application. Examples of first level actions may include importing trips, configuring mileage tracking, connecting a bank account, uploading a file, creating a transaction, viewing income, viewing expenses, setting goals, and/or the like. Minor intent 324 also has first level action 332 beneath it in the hierarchy. While not show, minor intent 322 may also have one or more minor intents beneath it.

Beneath first level action 334 in the hierarchy are two “second level” actions 336 and 338 at a fourth hierarchical level (e.g., which is the second level for actions but fourth level overall). Examples of second level actions include fixing a bank connection error, viewing transactions, creating a trip, setting up vehicles, reviewing trips, viewing a customer goal, and/or the like. While not shown, second level actions 336 may have one or more “third level” actions beneath them, and so on. Examples of third level actions may include reviewing transactions, viewing personal transactions, viewing business transactions, and/or the like.

In one particular example, major intent 310 is getting ready for taxes, minor intent 320 is allowing location services tracking, first level task 334 is configuring mileage tracking, second level action 336 is creating a trip, and second level action 338 is setting up vehicles.

The same action may be included below multiple minor intents. The same minor intent may be included below multiple major intents. The same lower-level action may be included below multiple higher-level actions.

The hierarchical arrangement shown in diagram 300 enables a more relational and contextualized view of each recommendable action to be provided to a machine learning model, and enables dynamic feedback-based scoring for use in providing focused and relevant context information to the machine learning model. Computing such scores may involve increasing the score of an action and/or an associated intent (e.g., above the action in the hierarchy) relative to other actions and/or intents when a user selects the action.

Consider an example where, prior to user interaction with a particular recommended action, major intent 310 has a score of 0.5 and major intent 390 has a score of 0.5 (e.g., indicating that these two major intents have previously received approximately equal amounts of interaction from the user). Furthermore, prior to user interaction with the particular recommended action, minor intent 320 has a score of 0.2, minor intent 322 has a score of 0.2, and minor intent 324 has a score of 0.6. Additionally, prior to user interaction with the particular recommended action, first level action 332 has a score of 0.4 and first level action 334 has a score of 0.6. Finally, prior to user interaction with the particular recommended action, second level action 336 has a score of 0 and second level action 338 has a score of 0.

Continuing the example, the user may select second level action 338 after second level action 338 was recommended to the user via a user interface. Based on such feedback, the scores mentioned above may be updated. The feedback may be seen as an indication that the user is interested in second level action 338, first level action 334 (which is an immediate parent of second level action 338 in the hierarchy), minor intent 320 (which is a grandparent of second level action 338 in the hierarchy), and major intent 310 (which is a great grandparent of second level action 338 in the hierarchy). A parent of a given entity may be an entity that is one hierarchical level above the given entity, a grandparent of the given entity may be an entity that is two hierarchical levels above the given entity, and a great grandparent may be an entity that is three hierarchical levels above the given entity.

For example, at each applicable hierarchical level the scores of all intents or actions at that level may be recomputed based on the selection of second level action 338. The formula may, for example, involve adding 1 to the previous score an action or intent that was determined to be of interest and dividing the resulting value by the sum of the resulting value and the scores of all other actions or intents at the same hierarchical level to produce the updated score for the action or intent that was determined to be of interest. The scores of all other actions or intents at that hierarchical level may each be divided by the sum of the resulting value (e.g., the value resulting from adding 1 to the previous score the action or intent that was determined to be of interest) and the scores of all of the other actions or intents at that hierarchical level. Such a process may create scores that are normalized at each hierarchical level.

At the second level action level, for example, 1 may be added to the previous score of second level action 338 (which was 0) to produce a resulting value of 1, and 1 may then be divided by the sum of 1 and the scores of all other actions or intents at the same hierarchical level (e.g., in this case, second level action 336 has a score of 0). Thus, the updated score of second level action 338 may be 1/1=1. The updated score of second level action 336 may be computed by dividing the previous score of second level action 336 (0) by 1 to produce an updated score of 0/1=0. Thus, in the depicted example, second level action 336 has a score of 0 while second level action 338 has a score of 1.

At the first level action level, for example, 1 may be added to the previous score of first level action 334 (which was 0.6) to produce a resulting value of 1.6, and 1.6 may then be divided by the sum of 1.6 and the scores of all other actions or intents at the same hierarchical level (e.g., in this case, first level action 332 has a score of 0.4). Thus, the updated score of first level action 334 may be 1.6/2=0.8. The updated score of first level action 332 may be computed by dividing the previous score of first level action 332 (0.4) by 2 to produce an updated score of 0.4/2=0.2. Thus, in the depicted example, first level action 332 has a score of 0.2 while first level action 334 has a score of 0.8.

At the minor intent level, for example, 1 may be added to the previous score of minor intent 320 (which was 0.2) to produce a resulting value of 1.2, and 1.2 may then be divided by the sum of 1.2 and the scores of all other actions or intents at the same hierarchical level (e.g., in this case, minor intent 322 has a score of 0.2 and minor intent 324 has a score of 0.6). Thus, the updated score of minor intent 320 may be 1.2/2=0.6. The updated score of minor intent 322 may be computed by dividing the previous score of minor intent 322 (0.2) by 2 to produce an updated score of 0.2/2=0.1. The updated score of minor intent 324 may be computed by dividing the previous score of minor intent 324 (0.6) by 2 to produce an updated score of 0.6/2=0.3. Thus, in the depicted example, minor intent 320 has a score of 0.6, minor intent 322 has a score of 0.1, and minor intent 324 has a score of 0.3.

At the major intent level, for example, 1 may be added to the previous score of major intent 310 (which was 0.5) to produce a resulting value of 1.5, and 1.5 may then be divided by the sum of 1.5 and the scores of all other actions or intents at the same hierarchical level (e.g., in this case, major intent 390 has a score of 0.5). Thus, the updated score of major intent 310 may be 1.5/2=0.75. The updated score of major intent 390 may be computed by dividing the previous score of major intent 390 (0.5) by 2 to produce an updated score of 0.5/2=0.25. Thus, in the depicted example, major intent 310 has a score of 0.75 and major intent 390 has a score of 0.25.

In some embodiments, hierarchically arranged tasks at three levels (L1, L2, and L3) associated with scores may be represented by the following example code:

```
TaskHierarchy = {
  ″L1_1″: {“score”:int( ),
    ″L2_1″: {“score”:int( ),
      ″L3_1″: {“score”:int( ), },
      ″L3_2″: {“score”:int( ), }
    },
    ″L2_2″: {“score”:int( ),
      ″L3_1″: {“score”:int( ), },
      ″L3_2″: {“score”:int( ), }
    },
  },
  ″L1_2″: {“score”:int( ),
    ″L2_1″: {“score”:int( ),
      ″L3_1″: {“score”:int( ), },
      ″L3_2″: {“score”:int( ), }
    }
  }
```

### Examples Relationships Between Events, Intents, and Data Sources

FIG. 4 is a diagram 400 illustrating example relationships between events, intents, and data sources related to automated software application guidance through intent-based machine learning, according to certain embodiments. Diagram 400 includes minor intents 320, 322, and 324 of FIG. 3.

In diagram 400, event 410 is associated with minor intents 320 and 322 while event 420 is associated with minor intents 322 and 324. Minor intent 320 is associated with data source list 413, minor intent 322 is associated with data source list 417, and minor intent 324 is associated with data source 423.

For example, events 410 and 420 may represent events that may occur within a software application, such as events that are included in configured trigger points 215 of FIG. 2 and that may be published to event bus 210 of FIG. 2. The associations indicated in diagram 400 may be included in configured intents and actions 250 of FIG. 2. Events may include, for example, completion of a workflow (e.g., an onboarding workflow) or action (e.g., navigating to a certain page or location within the application), configuration events (e.g., updating a user preference, connecting a separate user account such as a bank account to the application, and/or the like), security events, communication events, automated or assisted support events, combination of events (e.g., performing a particular action a particular number of times), and/or the like,

Data source lists 413, 417, and 423 may each include one or more data sources (e.g., one or more of data sources 220 of FIG. 2), such as including identifiers and/or addresses of such data source(s). For example, the associations in diagram 400 may indicate that if event 410 is detected then each unique data source in data source lists 413 and 417 may be queried for context information (e.g., subject in some embodiments to dynamic selection of such data sources based on scores associated with minor intents 320 and/or 322) while if event 420 is detected then each unique data source in data source lists 417 and 423 may be queried for context information (e.g., subject in some embodiments to dynamic selection of such data sources based on scores associated with minor intents 322 and/or 324).

It is noted that while diagram 400 depicts associations between events and minor intents and between minor intents and data sources, other embodiments may involve direct associations between events and actions and/or between actions and data sources. Furthermore, other embodiments may involve associations between events and major intents and/or between major intents and data sources. The associations depicted may involve implied or indirect relationships between events and actions and between actions and data sources, as each minor intent may include one or more action.

In some embodiments, a phased approach is used to incrementally gather more data (e.g., for inclusion in data sources 220 of FIG. 2) for use in automated application guidance techniques described herein. For example, in the context of a software application that relates to financial management and/or tax preparation, a first phase may involve acquiring data of financial transactions, a second phase may involve acquiring clickstream data, trips, tax audit logs, and other user data, and a third phase may involve acquiring other application data such as connections between users and/or businesses. In order to reduce density of data and increase the signal/noise ratio associated with using such data for automated application guidance techniques, the data acquired may be limited to that which is likely to be relevant to particular actions, intents, and/or events.

### Examples Operations for Related to Automated Software Application Guidance

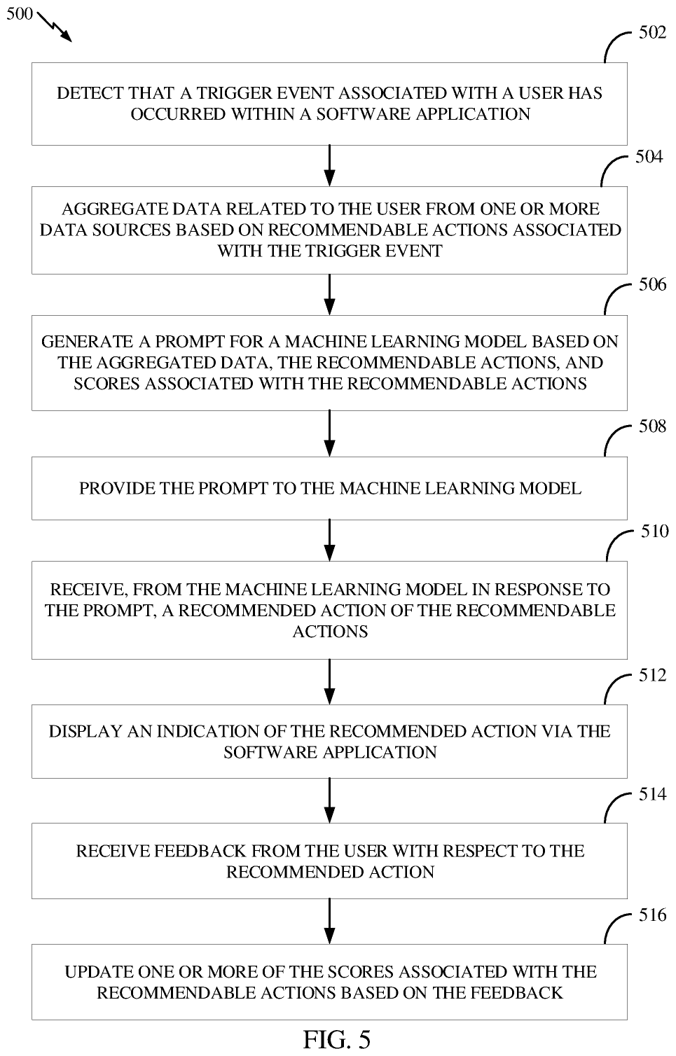

FIG. 5 depicts example operations 500 related to automated software application guidance, according to certain embodiments. For example, operations 500 may be performed by one or more components described above with respect to FIG. 2, system 600 of FIG. 6 (described below), and/or one or more other components and/or devices. In one particular example, operations 500 may be performed by targeted prediction engine 205 of FIG. 2.

Operations 500 begin at step 502, with detecting that a trigger event associated with a user has occurred within a software application.

Operations 500 continue at step 504, with aggregating data related to the user from one or more data sources based on recommendable actions associated with the trigger event.

Operations 500 continue at step 506, with generating a prompt for a machine learning model based on the aggregated data, the recommendable actions, and scores associated with the recommendable actions.

Operations 500 continue at step 508, with providing the prompt to the machine learning model.

Operations 500 continue at step 510, with receiving, from the machine learning model in response to the prompt, a recommended action of the recommendable actions.

Operations 500 continue at step 512, with displaying an indication of the recommended action via the software application.

Operations 500 continue at step 514, with receiving feedback from the user with respect to the recommended action.

Operations 500 continue at step 516, with updating one or more of the scores associated with the recommendable actions based on the feedback.

Some embodiments further comprise detecting a subsequent occurrence of the trigger event within the software application, aggregating corresponding data related to the user from the one or more data sources based on the recommendable actions associated with the trigger event, generating a subsequent prompt for the machine learning model based on the aggregated corresponding data, the recommendable actions, and the scores associated with the recommendable actions following the updating, providing the subsequent prompt to the machine learning model, receiving, from the machine learning model in response to the subsequent prompt, a given recommended action of the recommendable actions, and displaying a corresponding indication of the given recommended action via the software application.

In some embodiments, the feedback comprises the user performing the recommended action, and wherein the updating of the one or more of the scores associated with the recommendable actions based on the feedback comprises increasing a score associated with the recommended action. In certain embodiments, the updating of the one or more of the scores associated with the recommendable actions based on the feedback comprises performing score normalization across a set of the recommendable actions. In certain embodiments, the generating of the prompt for the machine learning model is further based on respective scores associated with intents corresponding to the recommendable actions.

Some embodiments further comprise updating one or more of the respective scores associated with the intents based on the feedback. In some embodiments, the intents comprise major intents and minor intents, and the minor intents are at a lower level in a hierarchy than the major intents, wherein the recommendable actions are at a lower level in the hierarchy than the minor intents, and wherein the generating of the prompt is further based on the hierarchy.

In some embodiments, the receiving, from the machine learning model in response to the prompt, the recommended action of the recommendable actions comprises receiving a structured object as an output from the machine learning model and the displaying of the indication of the recommended action via the software application comprises extracting an action identifier from the structured object and displaying the indication based on the action identifier.

In certain embodiments, the machine learning model outputs a natural language explanation in association with the recommended action, and wherein the natural language explanation is displayed with the indication of the recommended action via the software application.

In some embodiments, the generating of the prompt for the machine learning model based on the aggregated data, the recommendable actions, and the scores associated with the recommendable actions comprises generating context for inclusion in the prompt, the context comprising the aggregated data, the recommendable actions, and the scores associated with the recommendable actions.

In some embodiments, the generating of the prompt for the machine learning model based on the aggregated data, the recommendable actions, and the scores associated with the recommendable actions comprises including, in the prompt, weights for subsets of the aggregated data that are based on the scores associated with the recommendable actions.

Certain embodiments further comprise selecting the one or more data sources based on the scores associated with the recommendable actions.

Notably, method 500 is just one example with a selection of example steps, but additional methods with more, fewer, and/or different steps are possible based on the disclosure herein.

### Example Computing System

FIG. 6 illustrates an example computing system 600 with which embodiments of the disclosure related to automated software application guidance may be implemented. For example, the computing system 600 may perform functionality described above with respect to FIGS. 1-4, and/or may perform operations 500 of FIG. 5.

The computing system 600 includes a central processing unit (CPU) 602, one or more I/O device interfaces 604 that may allow for the connection of various I/O devices 604 (e.g., keyboards, displays, mouse devices, pen input, etc.) to the computing system 600, a network interface 606, a memory 608, and an interconnect 612. It is contemplated that one or more components of the computing system 600 may be located remotely and accessed via a network 610. It is further contemplated that one or more components of the computing system 600 may include physical components or virtualized components.

The CPU 602 may retrieve and execute programming instructions stored in the memory 608. Similarly, the CPU 602 may retrieve and store application data residing in the memory 608. The interconnect 612 transmits programming instructions and application data, among the CPU 602, the I/O device interface 604, the network interface 606, the memory 608. The CPU 602 is included to be representative of a single CPU, multiple CPUs, a single CPU having multiple processing cores, and other arrangements.

Additionally, the memory 608 is included to be representative of a random access memory or the like. In some embodiments, the memory 608 may include a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, the memory 608 includes application 614, which may be representative of a software application that provides functionality described herein, such as an application for which actions may be dynamically recommended as described herein. Memory 608 further includes targeted prediction engine 616, machine learning model 618, event bus 620, user interface 622, data sources 626, and database 628, which may representative of, respectively, targeted prediction engine 205, machine learning model 290, event bus 210, user interface 250, data sources 220, and database 295 of FIG. 2.

It is noted that system 600 is included as an example, and certain functionality described with respect to system 600 and/or otherwise described herein may be implemented via more or fewer devices and/or components.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for automated software application guidance, comprising:
detecting that a trigger event associated with a user has occurred within a software application;
aggregating data related to the user from one or more data sources based on recommendable actions associated with the trigger event;
generating a prompt for a machine learning model based on the aggregated data, the recommendable actions, and scores associated with the recommendable actions;
providing the prompt to the machine learning model;
receiving, from the machine learning model in response to the prompt, a recommended action of the recommendable actions;
displaying an indication of the recommended action via the software application;
receiving feedback from the user with respect to the recommended action; and
updating one or more of the scores associated with the recommendable actions based on the feedback.

2. The method of claim 1, further comprising:
detecting a subsequent occurrence of the trigger event within the software application;
aggregating corresponding data related to the user from the one or more data sources based on the recommendable actions associated with the trigger event;
generating a subsequent prompt for the machine learning model based on the aggregated corresponding data, the recommendable actions, and the scores associated with the recommendable actions following the updating;
providing the subsequent prompt to the machine learning model;
receiving, from the machine learning model in response to the subsequent prompt, a given recommended action of the recommendable actions; and
displaying a corresponding indication of the given recommended action via the software application.

3. The method of claim 1, wherein the feedback comprises the user performing the recommended action, and wherein the updating of the one or more of the scores associated with the recommendable actions based on the feedback comprises increasing a score associated with the recommended action.

4. The method of claim 3, wherein the updating of the one or more of the scores associated with the recommendable actions based on the feedback comprises performing score normalization across a set of the recommendable actions.

5. The method of claim 1, wherein the generating of the prompt for the machine learning model is further based on respective scores associated with intents corresponding to the recommendable actions.

6. The method of claim 5, further comprising updating one or more of the respective scores associated with the intents based on the feedback.

7. The method of claim 6, wherein the intents comprise major intents and minor intents, wherein the minor intents are at a lower level in a hierarchy than the major intents, wherein the recommendable actions are at a lower level in the hierarchy than the minor intents, and wherein the generating of the prompt is further based on the hierarchy.

8. The method of claim 1, wherein the receiving, from the machine learning model in response to the prompt, the recommended action of the recommendable actions comprises receiving a structured object as an output from the machine learning model, and wherein the displaying of the indication of the recommended action via the software application comprises extracting an action identifier from the structured object and displaying the indication based on the action identifier.

9. The method of claim 1, wherein the machine learning model outputs a natural language explanation in association with the recommended action, and wherein the natural language explanation is displayed with the indication of the recommended action via the software application.

10. The method of claim 1, wherein the generating of the prompt for the machine learning model based on the aggregated data, the recommendable actions, and the scores associated with the recommendable actions comprises generating context for inclusion in the prompt, the context comprising the aggregated data, the recommendable actions, and the scores associated with the recommendable actions.

11. The method of claim 1, wherein the generating of the prompt for the machine learning model based on the aggregated data, the recommendable actions, and the scores associated with the recommendable actions comprises including, in the prompt, weights for subsets of the aggregated data that are based on the scores associated with the recommendable actions.

12. The method of claim 1, further comprising selecting the one or more data sources based on the scores associated with the recommendable actions.

13. A system for automated software application guidance, comprising:
one or more processors; and
a memory comprising instructions that, when executed by the one or more processors, cause the system to:
detect that a trigger event associated with a user has occurred within a software application;
aggregate data related to the user from one or more data sources based on recommendable actions associated with the trigger event;
generate a prompt for a machine learning model based on the aggregated data, the recommendable actions, and scores associated with the recommendable actions;
provide the prompt to the machine learning model;
receive, from the machine learning model in response to the prompt, a recommended action of the recommendable actions;
display an indication of the recommended action via the software application;
receive feedback from the user with respect to the recommended action; and
update one or more of the scores associated with the recommendable actions based on the feedback.

14. The system of claim 13, wherein the instructions, when executed by the one or more processors, further cause the system to:
detect a subsequent occurrence of the trigger event within the software application;
aggregate corresponding data related to the user from the one or more data sources based on the recommendable actions associated with the trigger event;
generate a subsequent prompt for the machine learning model based on the aggregated corresponding data, the recommendable actions, and the scores associated with the recommendable actions following the updating;
provide the subsequent prompt to the machine learning model;
receive, from the machine learning model in response to the subsequent prompt, a given recommended action of the recommendable actions; and
display a corresponding indication of the given recommended action via the software application.

15. The system of claim 13, wherein the feedback comprises the user performing the recommended action, and wherein the updating of the one or more of the scores associated with the recommendable actions based on the feedback comprises increasing a score associated with the recommended action.

16. The system of claim 15, wherein the updating of the one or more of the scores associated with the recommendable actions based on the feedback comprises performing score normalization across a set of the recommendable actions.

17. The system of claim 13, wherein the generating of the prompt for the machine learning model is further based on respective scores associated with intents corresponding to the recommendable actions.

18. The system of claim 17, wherein the instructions, when executed by the one or more processors, further cause the system to update one or more of the respective scores associated with the intents based on the feedback.

19. The system of claim 18, wherein the intents comprise major intents and minor intents, wherein the minor intents are at a lower level in a hierarchy than the major intents, wherein the recommendable actions are at a lower level in the hierarchy than the minor intents, and wherein the generating of the prompt is further based on the hierarchy.

20. A non-transitory computer readable medium comprising instructions that, when executed by one or more processors of a computing system, cause the computing system to:
detect that a trigger event associated with a user has occurred within a software application;
aggregate data related to the user from one or more data sources based on recommendable actions associated with the trigger event;
generate a prompt for a machine learning model based on the aggregated data, the recommendable actions, and scores associated with the recommendable actions;
provide the prompt to the machine learning model;
receive, from the machine learning model in response to the prompt, a recommended action of the recommendable actions;
display an indication of the recommended action via the software application;
receive feedback from the user with respect to the recommended action; and
update one or more of the scores associated with the recommendable actions based on the feedback.
